(19) United States
(12) Patent Application Publication
(10) Pub. No.: US 2023/0168646 A1
(43) Pub. Date: Jun. 1, 2023

(54) SCALABLE EMULATED CYBER RANGE ENVIRONMENT

(71) Applicant: UCHICAGO ARGONNE, LLC, Chicago, IL (US)

(72) Inventors: Joshua A. Lyle, Plainfield, IL (US); Nathaniel Evans, Orland Hills, IL (US); Steven Day, Lemont, IL (US)

(73) Assignee: UCHICAGO ARGONNE, LLC, Chicago, IL (US)

(21) Appl. No.: 17/537,093

(22) Filed: Nov. 29, 2021

(51) Int. Cl. G05B 17/02; G05B 13/04; G05B 19/048

(52) U.S. Cl. CPC G05B 17/02; G05B 13/04; G05B 19/048

(57) ABSTRACT

At least one embodiments relates to a system for testing industrial processes and industrial control systems including a physical environment, including at least one industrial control system hardware and at least one physical model, and a computer system comprising a processor and a memory, wherein the processor is set up to perform operations, embodied in instructions on computer-readable medium. The operations include virtually linking the physical environment and a virtual environment, inputting at least one document comprising supporting software and a scenario instruction set, generating a scenario according to the scenario instruction set, simulating the scenario, and displaying simulation results of the simulated scenario.

### BACKGROUND

When compared with traditional information technology (IT) systems, industrial control systems and their supporting infrastructure are often setup and neglected. Traditional IT systems often undergo auditing, penetration testing, and monitoring.

Industrial control systems require physical components that cannot be easily replicated for examination and testing. Industrial control systems are often deployed in critical environments that don't have the flexibility for the downtime required for proper penetration testing and analysis. This leads to industrial control systems becoming vulnerable over time as their software and supporting infrastructure go unpatched and unchanged for long periods of time making them susceptible to new exploits.

### SUMMARY

At least one embodiment relates to a system for testing industrial processes and industrial control systems including a physical environment, including at least one industrial control system hardware and at least one physical model, and a computer system comprising a processor and a memory, wherein the processor is set up to perform operations, embodied in instructions on computer-readable medium. The operations include virtually linking the physical environment and a virtual environment, inputting at least one document comprising supporting software and a scenario instruction set, generating a scenario according to the scenario instruction set, simulating the scenario, and displaying simulation results of the simulated scenario.

Another embodiment relates to a method for simulating industrial processes and industrial control systems on a testbed including integrating, by a processor, a physical environment with a virtual environment, inputting, by the processor, at least one document comprising supporting software, generating by the processor, a scenario environment including the physical environment and the virtual environment linked as described in the at least one document, generating, by the processor, a scenario within the scenario environment as described in the at least once document, and simulating, by the processor, the scenario.

Another embodiment relates to a non-transitory computer readable media having computer-executable instructions embodied therein that, when executed by a computing system, causes the computing system to perform operations including integrating, by a processor, a physical environment with a virtual environment, inputting, by the processor, at least one document comprising supporting software, generating, by the processor, a scenario environment including the physical environment and the virtual environment linked as described in the at least one document; and simulating, by the processor, a scenario.

This summary is illustrative only and is not intended to be in any way limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a testbed system, according to an example embodiment.

FIG. 2 is a block diagram of a method for using a testbed system, according to an example embodiment.

FIG. 3 is a block diagram of a method of interacting with a testbed system, according to an example embodiment.

FIG. 4 is a testbed system, according to an example embodiment.

### DETAILED DESCRIPTION OF THE DRAWINGS

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As used herein, the term “ICS” refers to an industrial control system(s). An ICS includes at least one control system, comprising software and/or hardware configured to control and manage industrial (e.g., manufacturing, energy management, etc.) processes.

As used herein, the term “IT” refers to information technology. IT includes computing systems and their components configured to create, process, store, and exchange data and information.

As used herein, the term “testbed” refers to hardware and/or software for conducting tests. A testbed provides a space for testing changes to components or configurations such that the results of the changes may be observed.

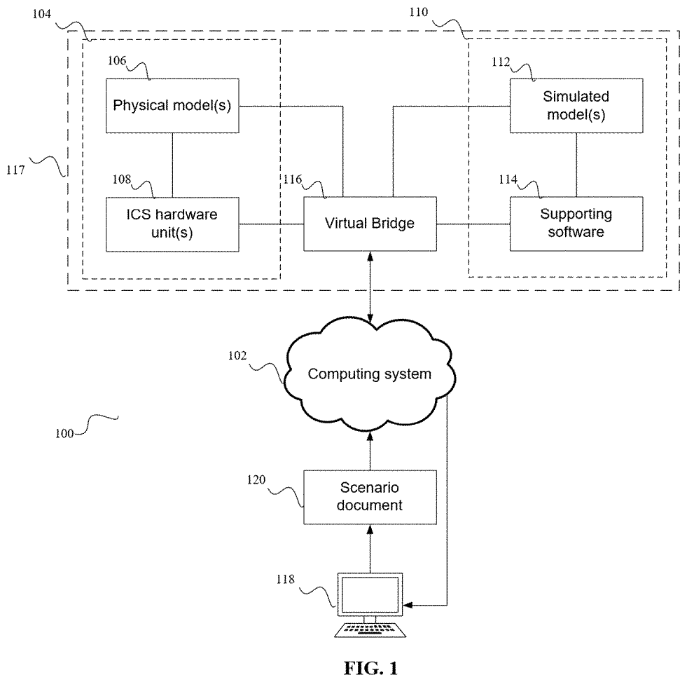

Referring now to FIG. 1, a testbed system 100 for simulating industrial processes (e.g., manufacturing step, energy transmission, etc.), ICS, and supporting IT infrastructure is shown. Industrial systems (e.g., manufacturing plant, energy infrastructure, etc.) are often difficult to simulate as their components can often not be taken out of operation for testing. This opens industrial systems to vulnerabilities in their IT infrastructure. Such vulnerabilities can leave the industrial systems as targets for malicious actors or vulnerable to failure. The testbed system 100 provides industrial systems with a range for testing systems and identifying vulnerabilities early, before a potential attack or failure. In some embodiments, the testbed system 100 may be reconfigured, on the fly, for educational and research purposes. For example, the testbed system 100 may be used for teaching a group of students about industrial processes and potential vulnerabilities. Additionally, the testbed system 100 may communicate across a centralized hub for cross-platform use between labs, academia, and industry.

The testbed system 100 operates (e.g., functions are completed) on a computing system 102. The computing system 102 includes a processor. In some embodiments, the processor includes one or more microprocessors, application specific integrated circuits (ASICs), field programmable gate array (FPGAs), other forms of processing circuits, or combinations thereof. The computing system 102 further includes data storage. For example, the data storage may include electronic, optical, magnetic, or any other storage or transmission device capable of providing the processor with program instructions. The data storage may include storage devices such as a floppy disk, CD-ROM, DVD, magnetic disk, memory chip, ROM, RAM, EEPROM, EPROM, flash memory, optical media, or any other suitable memory form which the processor can ready instructions and/or data. In some embodiments, the data storage includes an application (e.g., computer program designed to carry out specific task), through which the testbed system 100 may be managed.

In some embodiments, the computing system 102 may be a computer cluster (e.g., set of intercommunicating computers operating together). In some embodiments, the computing system 102 integrates (e.g., wirelessly connects, electrically connects, etc.) with a cloud-based computing system (e.g., externally stored computing system). The cloud computing system includes at least one processor and data storage distributed over at least one location externally (e.g., not co-located with testbed system). In some embodiments, the testbed system 100 wholly operates within the cloud computing system. To access the cloud-based computing system, the testbed system 100 may include a communication device comprising at least a transmitter and a receiver for accessing the cloud-based computing system. In some embodiments, the computing system 102 operation on an OpenStack cloud-computing platform configured to communicably couple to physical modules (e.g., physical hardware) that may be attached or detached depending on system design. The computing system 102 may operate on a variety of operating system including Windows, Linux, an embedded operating system, etc.

In some embodiments, the computing system 102 may be externally (e.g., not part of testbed system 100) accessed. For example, the computing system 102 may connect to labs, academia, and industry to provide a cross-platform hub for information transfer. Additionally, the computing system 102 may connect to classrooms or workforce development programs to serve as a training and education aid.

The testbed system 100 includes a physical environment 104. The physical environment 104 provides the testbed system 100 with real-world (e.g., existing physically) equipment for testing industrial processes. Virtual (e.g., computer-based) equipment and simulations are often limited in their scope and cannot model every aspect of the real-world equipment they are meant to represent. Therefore, having a physical environment 104 as part of the testbed system 100 increases the accuracy of simulations and tests run on the testbed system 100. Including a physical environment 104 is especially beneficial when the physical environment 104 includes critical (e.g., essential for success) components of an ICS, or with components that may be too complex, or may be too resource intensive, to simulate or model virtually. In some embodiments, the physical environment 104 may be configured to operate as an internet of things.

The physical environment 104 includes an at least one physical model 106. The at least one physical model 106 may be a component, such as a critical infrastructure system, (e.g., wind-powered energy generation, oil and natural gas pipeline, solar energy generation, high performance computing datacenter, water treatment, natural gas system, manufacturing plant, electrical substation, electrical distribution, etc.) of an industrial process or may be a model (e.g., scale model, functional model, etc.) of a component of an industrial process. Modeling a process or component may reduce complexity, thus reducing processing time and cost.

The at least one physical model 106 may include electrical hardware (e.g., processor, data storage, etc.) configured to manage (e.g., control function of) the physical model 106. In some embodiments, each physical model 106 is configured to send and receive signals that include information and instructions relating to the operation and status of the physical model 106. In some embodiments, the operation and status of the physical model 106 may be monitored by an external device (e.g., camera, sensor, etc.). The external device may be configured to send data corresponding to the operation and status of the physical model 106. In some embodiments, the physical environment 104 includes more than one physical model 106 coupled (e.g., wirelessly, electrically, physically, etc.) to a different physical model 106. In some embodiments, the physical environment 104 may be configured to include at least one additional physical model 106 that may not be part of an industrial process (e.g., vehicle, weapons system, satellite communication, quantum communication, etc.).

The physical environment 104 also includes at least one ICS hardware unit 108. The at least one ICS hardware unit 108 is configured to operate (e.g., provide instructions to) a corresponding physical model 106. The ICS hardware unit 108 includes both physical hardware (e.g., cables, input devices, etc.) and electrical hardware (e.g., processor, data storage, etc.) configured for operating the corresponding physical model 106. For example, the ICS hardware unit 108 may include a processor, data storage, a computer monitor, a keyboard, and cables configured for sending and receiving signals to a physical model 106.

The ICS hardware unit 108 may operate the corresponding physical model 106 automatically (e.g., without input) or may require input from a user. The ICS hardware unit 108 may be configured to control more than one physical model 106 simultaneously. The ICS hardware unit 108 may be a component of an industrial control system or a full industrial control system. In some embodiments, more than one ICS hardware unit 108 may be coupled (e.g., wirelessly, electrically, etc.) together to form a full industrial control system. For example, more than one ICS hardware unit 108 may be connected via Wi-Fi to a network. In some embodiments, the ICS hardware unit 108 may operate on a server stored either locally or externally to the testbed system 100. In some embodiments, the ICS hardware unit 108 may include software or instructions configured to operate the corresponding physical model 106.

In some embodiments, the ICS hardware unit 108 includes cyber-security measures (e.g., firewall, intrusion detection, response systems, etc.) that protect the at least one physical model 106 associated with the ICS hardware unit 108.

The at least one physical model 106 and the at least one ICS hardware unit 108 are interlinked (e.g., wirelessly, electrically, physically, etc.) to create the physical environment 104. The physical environment 104 may configured to operate independently (e.g., without outside input) or may require additional external components to function.

The testbed system 100 includes a virtual environment 110 that can be used to scale out and replicate deployments (e.g., introduction of new components). The virtual environment 110 provides the testbed system 100 with an environment for deploying and testing industrial processes and components of industrial processes virtually (e.g., operating wholly within at least one computing system). The virtual environment 110 includes virtual equipment for testing and simulating processes as well as interconnecting a variety of other virtual equipment and processes together in customizable ways. A benefit of using virtual equipment over physical equipment is that some physical equipment may be too cost prohibitive to test physically, thus it is built in a virtual environment. Additionally virtual equipment can be replicated quickly and without a limit of scale.

The virtual environment 110 allows for testing components of an ICS that may not be part of the physical environment 104. In some embodiments, the virtual environment 110 includes a simulated version of the physical environment 104, or of components of the physical environment 104. Including a simulated version of the physical environment into the virtual environment 110 provides redundancy and allows for testing components of the physical environment 104 that cannot be tested physically. In some embodiments, the virtual environment 110 is stored on a data storage device (e.g., hard-drive, solid-state drive, etc.) and is inputted into the computing system 102. The virtual environment 110 includes at least one simulated model 112. The at least one simulated model 112 represent a component of an ICS virtually. Representing a component of an ICS virtually allows the testbed system 100 to include and test components of an ICS that cannot be tested physically. For example, IT systems for businesses cannot be tested, as the IT system needs to be operating at full capacity and cannot be used for testing purposes.

The virtual environment 110 includes supporting software 114. The supporting software 114 is software (e.g., computer-readable instructions and data) configured to operate the at least one simulated model 112. Additionally, the supporting software 114 is configured to simulate functions of an ICS. Simulations, as part of the supporting software 114 may be pre-configured to complete a certain task (e.g., cyber-security threat, system failure, etc.) or may include computer algorithms (e.g., machine learning, artificial intelligence, etc.) configured to create varied scenarios for simulation. The supporting software 114 may be stored on data storage within the virtual environment 110 or may be stored on data storage within the computing system 102. In some embodiments, the supporting software may be part of the simulated model 112. In some embodiments, the supporting software 114 may be stored in a software bank within the virtual environment 110. For example, only supporting software 114 that is needed is accessed from the software bank during testbed system 100 operation.

The computing system 102 integrates the physical environment 104, and all components, with the virtual environment 110, and all components, through a virtual bridge 116. The virtual bridge 116 connects the physical environment 104 and the virtual environment 110 to create a simulation network 117. The virtual bridge 116 forms the simulation network 117 by connecting any components within the physical environment 104 and the virtual environment 110 configured to send and receive data and/or signals. The virtual bridge 116 then normalizes any inputted and outputted data and signals such that each component of the physical environment 104 and the virtual environment 110 may communicate to other components. In some embodiments, the virtual bridge may connect to infrastructure (e.g., computing systems, physical systems, etc.) outside of the virtual environment 110 and the physical environment 104. When the computing system 102 is a computer cluster, the virtual bridge 116 utilizes the interconnectedness of the computer cluster to form the simulation network. The computer cluster can physically (e.g., wired or wireless connection) connect to the physical environment 104. To connect to the virtual environment 104, the computer cluster may utilize virtual clusters within the computer cluster. The virtual bridge 116 then interconnects the physical environment 104 and the virtual environment 110.

The simulation network 117 represents an equivalent industrial process and supporting ICS. The simulation network 117 serves as a range (e.g., space for testing) for simulating and testing the equivalent industrial process and supporting ICS. Simulating and testing can reveal weaknesses (e.g., points of failure, security lapses, etc.) within the industrial process and supporting ICS. A benefit of the simulation network 117 is that it does not bring the equivalent industrial process and supporting ICS offline, allowing for testing and simulation during use. The simulation network 117 may be scaled (e.g., reconfigured in size and scope) and reconfigured to represent different configurations of an industrial process and supporting ICS.

The testbed system 100 includes a managing device 118. The managing device 118 includes a processor and memory storage. The managing device 118 is configured to send and receive data and signals to and from the computing system 102. The sending and receiving may be through a wired (e.g., cable, etc.) or wireless (e.g., through the internet, Wi-Fi, Bluetooth, etc.) communication devices. In some embodiments, the managing device 118 may include instructions to a user for inputting data. In some embodiments, the managing device 118 may be data stored within the computing system 102. For example, the managing device 118 may be an application within a cloud computing service within computing system 102, accessed by a user through the internet. In some embodiments, the managing device 118 may be a mobile device configured to only send and receive data and signals wirelessly (e.g., Wi-Fi, Bluetooth, etc.).

The managing device 118 drafts a scenario document 120. The scenario document 120 includes data and instructions for a scenario to be simulated by the computing system 102. The scenarios represent situations the equivalent industrial process and supporting ICS of the simulation network 117 may encounter during operation. In some embodiments, the scenario may be a situation outside of scope of the equivalent industrial process and supporting ICS. The scenario document 120 can be extended or reconfigured to be applicable to variety of simulation network 117. The scenario document 120 may include additional supporting software configured to support the scenario as described in the scenario document 120. In some embodiments, the scenario document 120 includes multiple sets of data and instructions and may describe multiple scenarios. The scenario document 120 may include scaling or reconfiguring of the components of the simulation network 117. For example, the scenario document may include increasing the complexity of a physical model 106 representing an electrical grid. In some scenarios the scenario document 120 only includes instructions for accessing a portion of the components of the simulation network 117 and may include instruction for deactivating certain components. In some embodiments, the scenario documents include instructions for integrating with at least one additional physical model 106 and/or includes instruction for including at least one additional simulated model 112.

After the scenario document 120 is drafted, the scenario document 120 is then sent, by the managing device 118, to the computing system 102. The scenario document 120 is then processed by the computing system 102. In some embodiments, the scenario document directs the computing system 102 to access supporting software 114 from a software bank within the virtual environment 110. The computing system 102 generates the scenario as described in the scenario document 120. In some embodiments, the computing system 102 may store the generated scenario in a temporary data storage (e.g., RAM) and may access the generated scenario multiple times. As per the instructions stored within the scenario document, the computing system 102 then completes tests and simulations associated with the generated scenario. In some embodiments, the computing system 102 includes real-time feedback during the testing and simulation process, relayed to the managing device 118.

After the computing system 102 completes the instructions as described in the scenario document 120, the computing system 102 returns scenario results to the managing device 118. The scenario results may be reported as text, numerically, graphically, or any combination thereof. After the managing device 118 receives results from the computing system 102, an additional scenario document 120 may be drafted and inputted into the computing system 102, or an existing scenario document 120 may be reconfigured and inputted into the computing system 102. In some embodiments, the scenario document 120 may be redrafted automatically by a computing system (e.g., by employing machine learning, artificial intelligence, etc.). Quickly swapping between scenarios allows for a wide range of situations to be tested and simulated, revealing potential weaknesses in the current design. Testing new and innovative software and techniques, as drafted in the scenario document 120, without the risk of downtime or misconfiguration of the system being testing, encourages experimentation and innovation within an environment that typically is restricted in its ability to explore alternative configuration in a representative environment.

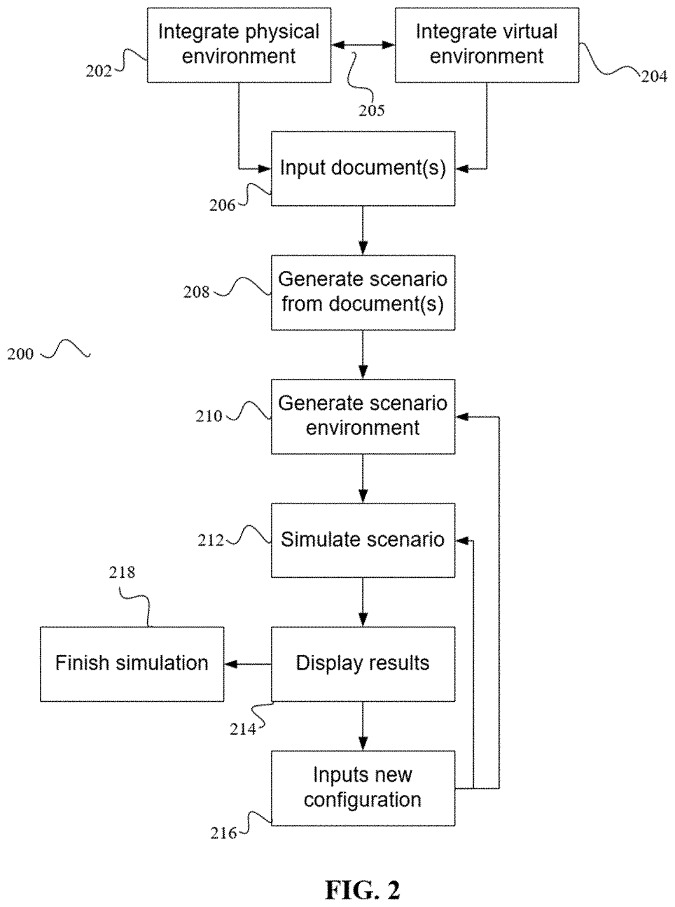

Referring now to FIG. 2, a simulating method 200, as completed by a testbed system 100, is shown, according to an example embodiment. In some embodiments, the simulating method 200 is completed automatically (e.g., without input from a user or operator). The simulating method 200 may be applied to various embodiments of the testbed system 100, such as the when the components of the testbed system 100 are scaled (e.g., changed in size or scope).

At 202, the testbed system 100 integrates a physical environment, such as the physical environment 104. Integrating the physical environment 104 includes interconnecting the components of the physical environment 104. 202 further includes configuring the physical environment 104 for communication with systems and components outside of the physical environment 104. In some embodiments, devices (e.g., sensors, processors, etc.) are included on the components of the physical environment 104 that may facilitate intercommunication of the components. For example, the physical environment 104 may be fully interconnected and communicative thus forming an intranet-of-things. In some embodiments, integrating the physical environment 104 includes updating software (e.g., drivers) of supporting components of the physical environment 104. In some embodiments, integrating the physical environment 104 includes maintaining (e.g., cleaning, replacing, etc.) components of the physical environment 104.

At 204, the testbed system 100 integrates a virtual environment, such as the virtual environment 110. Integrating the virtual environment 110 includes interconnecting the components of the virtual environment 110. 204 further includes configuring the virtual environment 110 for communication with systems and components outside of the virtual environment 110. In some embodiments, integrating the virtual environment 110 may include updates (e.g., software patches).

At 205, the physical environment 104 following integration and the virtual environment 110 following integration are linked together by a virtual bridge 116. The virtual bridge 116 is configured to interconnect the physical environment 104 and the virtual environment 110. The virtual bridge allows the components of the physical environment 104 and the components of the virtual environment 110 to communicate. In one embodiment, the virtual bridge uses Openstack virtual cluster to connect.

At 206, at least one document is inputted into the testbed system 100. The computing system 102 of the testbed reads-in (e.g., processes, receives data, etc.) the document(s) and all information and data included in the document(s). The document(s) describe a scenario to be simulated and includes additional supporting software for the scenario. In some embodiments, the document(s) include instructions for reconfiguring components of the testbed system 100. The instructions are then implemented by a user, or automatically by the computing system 102. For example, the document(s) may include initial positions for the components of the physical environment 104. These initial positions may then be adjusted manually or may be adjusted automatically by a computer and associated hardware.

At 208, the testbed system 100 generates a scenario environment, as described in the document(s) inputted at 206. Generating the scenario environment involves setting up (e.g., modifying conditions, applying rules, etc.) each component of the physical network 104 and each component of the virtual environment 110 as described in the document(s), as well as modifying the connections between the components. Generating the scenario environment may include scaling and duplication of components of the virtual environment 110 within the scenario environment. For example, if the virtual environment include a model of a windmill, the document may instruct the testbed system 100 to generate 100 models of windmills within the scenario environment. Scaling and duplication allow for the testbed system 100 to model varying situations. Generating the scenario environment also sets up the testbed system 100 for simulation.

At 212, the testbed system 100 simulates a scenario following the instruction in the document(s). Once the scenario environment is generated, the scenario is simulated. In some embodiments, the simulation may be predetermined (e.g., described specifically in the document(s)) or may be randomized. In some embodiments, the simulation may include some features that are predetermined and some features that are randomized. In some embodiments, the simulation may display results in real-time. In other embodiments, the testbed system 100 may not display any results while the simulation is running.

At 214, the testbed system 100 displays results from the simulation of 212. The results of the simulation may be displayed graphically, as raw-data (e.g., machine-readable code, an array of values, etc.), with text, or by other methods of communication. The results may be displayed physically (e.g., printed) or digitally (e.g., on a monitor, screen, etc.).

At 216, the testbed system 100 inputs a new configuration. The new configuration may be a new document describing a scenario or may be a separate scenario in the initially inputted document(s). In some embodiments, the new configuration may include additional supporting software. In some embodiments, the new configuration is generated automatically by the testbed system 100 to simulate a variety of configurations. In some embodiments, the automatic generation may be procedural (e.g., iteration, etc.) or may be generated by an algorithm (e.g., machine learning, artificial intelligence, etc.). After the new configuration is inputted, the testbed system 100 may generate a new scenario environment, or may generate the scenario if a new environment is not needed.

At 218, the testbed system 100 finishes the simulation. Finishing the simulation may be automatic, after the scenario is completed and the results are completed. In some embodiments, finishing the simulation may be initiated after the testbed system 100 receives a signal such as from a user, a timer, or other signal generating device. The testbed system 100 may additionally clear temporary storage (e.g., RAM, etc.) as to prepare the testbed system for reuse.

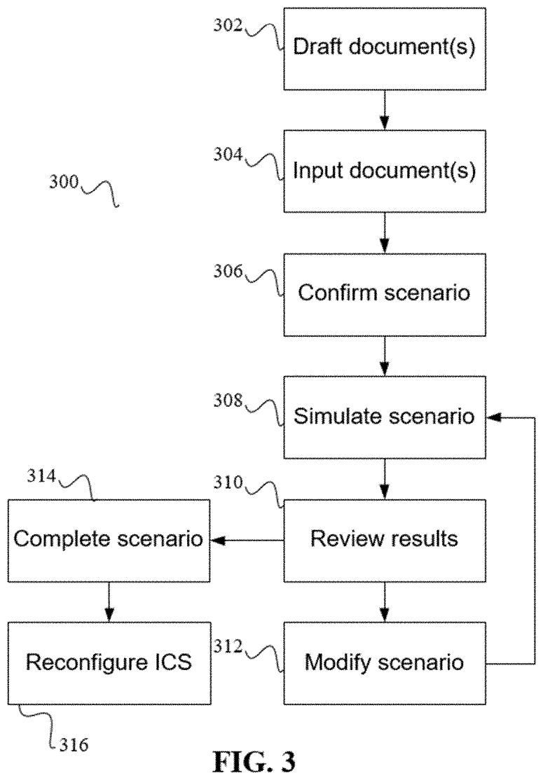

Referring now to FIG. 3, a user method 300 as completed by a user is shown, according to an example embodiment. For example, a user may be a manager of a plant, a student learning about industrial processes, or a researcher, among other occupations.

At 302, the user drafts at least one document. The document(s) describes a scenario the user intends to simulate on the testbed system 100. For example, if the user intends to simulate three windmills, a power generator, and the supporting IT infrastructure, the user then drafts at least one document describing the components and how they are interconnected. The document(s) is drafted on the managing device 118. In some embodiments, the document(s) is drafted externally and then transferred to the managing device 118. In some embodiments, the user create or deploy supporting software associated with the scenario in order to test its effectiveness. In some embodiments, the document may be drafted on an application on the managing device 118. The application is configured to provide the user with an interface or guide for setting up the scenario in the document.

At 304, the user inputs the at least one document into a testbed system 100. The document(s) is inputted into the testbed system 100 by the managing device 118. The computing system 102 of the testbed system 100 then reviews the document(s) as inputted by the user. The computing system 102 then generates the scenario. In some embodiments, the computing system 102 may be connected to the managing device 118 and may generate the scenario while the user is drafting the document(s). Once the scenario is generated, the computing system 102 reports the scenario and scenario parameters back to the user for user review.

At 306, the user reviews and confirms a scenario, as generated by the testbed system 100. In some embodiments, the user may adjust the configuration of the scenario during review. A benefit of reviewing the scenario is that the simulation process may be time or cost intensive and reviewing the scenario prior to simulation allows the user to notice any mistakes that may have been missed while drafting the document(s). In some embodiments, the user method 300 continues from 304 directly to 308, skipping 306.

At 308, the user initiates the testbed system 100 to simulate the scenario. The simulation may be interactive, meaning the user may input additional commands and instructions while the scenario is being simulated. The results of the simulation may be displayed in real-time and may allow for a user to input commands and instructions responsive to the results. In some embodiments, the results of the scenario may be displayed while the scenario is being simulated. After the simulation is completed, the user may be notified by a component of the testbed system 100 configured to notify. The notification can be digital (e.g., graphical interface, etc.) or analog (e.g., visual, audio, etc.). The testbed system 100 then reports the results back to the user. In some embodiments, the testbed system 100 may automatically begin simulating the scenario after the document(s) are inputted.

At 310, the user reviews the results of the scenario simulation. Reviewing the results aids the user in identifying strengths and weaknesses in the industrial processes and ICS the testbed system represents. This allows the user to improve systems and infrastructure to identify and avoid problems before they occur.

At 312, the user modifies the scenario. Modifying the scenario allows the user to try new configurations responsive to the strengths and weaknesses identified when reviewing the results. In some embodiments, modifying the scenario may require the user to draft a new document.

At 314, the user completes the scenario, once the user is finished with the scenario. In some embodiments, the user may need to manually reset the testbed system 100 and clear any temporary data stored in the memory of the components of the testbed system 100. In other embodiments, these steps may happen automatically. The user completes the scenario by inputting instructions (e.g., clicking a button, closing a computer window, etc.).

At 316, the user reconfigures the ICS and industrial processes. The user applies what is learned from the simulation to the ICS and industrial processes. These changes result in safer and more secure industrial processes and associated ICS.

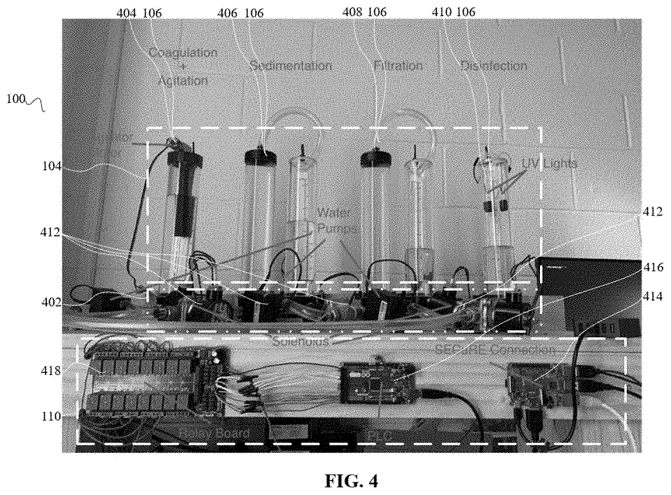

Referring now to FIG. 4, a testbed system 100 is shown, according to another example embodiment.

The testbed system 100 includes a physical environment 104. In this embodiment, the physical environment 104 includes four physical models 106. The physical models represent a coagulation and agitation process 404, a sedimentation process, 406, a filtration process 408, and a disinfection process 410. Each physical model 106 represents a step or component of an industrial process. Each physical model 106 includes associated hardware (e.g., sensors, pumps, cables, wires, etc.) that facilitate the function and communicability of each physical model 106. The associated hardware varies depending on the type of physical model 106 such that each physical model can properly function and be able to communicate any necessary data.

The testbed system 100 further includes process hardware 402. The process hardware 402 connects to each of the physical model 106 and facilities the operation of each physical model 106. In this embodiment, the process hardware 402 are water pump assemblies 412 comprising solenoids and water pumps. The water pump assemblies control the water flow into and out of the four physical model 106 during operation of the testbed system 100. The water pump assemblies may be actuated electrically.

The testbed system 100 includes a virtual environment 110. In some embodiments, the virtual environment 110 includes at least one simulated model 112 stored in a memory within the virtual environment 110.

The virtual environment 110 includes a connecting device 414. The connecting device 414 integrates the testbed system 100 with an external computing system 102. In this embodiment, the testbed system 100 is connected to the computing system 102 via the internet. The connecting device 414 includes the virtual bridge 116, interconnecting the various components of the testbed system 100. The virtual bridge 116 of the connecting device 414 communicatively couples to the virtual bridge 116 located within the external computing system 102. The connecting device 414 also includes slots for connecting additional input and output devices, such as a keyboard, computer mouse, and monitor. In this embodiment, the connecting device 414 is a Raspberry Pi computer. In some embodiments, the connecting device 414 may be any device configured to send and receive signals.

The virtual environment 110 includes a logic circuit 416. The logic circuit connects to the connecting device 414. The logic circuit 416 is a programmable logic circuit, a type of an industrial computer useful for controlling electro-mechanical processes. The logic circuit 416 receives instructions from the connecting device 414 and processes the instructions. The logic circuit 416 then output signals for operating functions of the testbed system 100. In this embodiment, the logic circuit 416 is an Arduino.

The virtual environment 110 includes a relay board 418. The relay board connects to the logic circuit 416. The relay board includes a plurality of relays (e.g., electrically operated switches) that actuate based on the signals received from the logic circuit 416. The relay board connects to the process hardware 402 and actuates the water pump assembly 412 by sending signals as directed by the logic circuit 416.

During operation of the testbed system 100, the components of the testbed system 100 follow instructions inputted into the testbed system 100 to simulate industrial processes and an associated ICS. The testbed system 100 is reusable and can be reconfigured for other scenarios. Reconfiguring can include at least replacing the physical model 106, including additional physical model 106, or changing the electronic components and the data stored within.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled direction to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structure and which can be accessed by a general purpose or special purpose computer or other machine with a processor. Combinations of the above are also included in the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system and method as shown in the various exemplary embodiments is illustrative only. Additionally, any element disclosed in one embodiment may be incorporated or utilized with any other embodiment disclosed herein. For example, the cloud based computing system of the exemplary embodiment described in at least paragraph [0018] may be incorporated in the testbed system of the exemplary embodiment described in at least paragraph [0056]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for testing industrial processes and industrial control systems comprising:
a physical environment comprising:
at least one industrial control system hardware; and
at least one physical model; and
a computer system comprising a processor and a memory, wherein the processor is set up to perform operations, embodied in instructions on computer-readable medium, the operations comprising:
virtually link the physical environment and a virtual environment;
input at least one document comprising supporting software and a scenario instruction set;
generate a scenario according to the scenario instruction set;
simulate the scenario; and
display simulation results of the simulating of the scenario.

2. The system of claim 1, wherein the at least one physical model and the at least one industrial control system hardware are interconnected.

3. The system of claim 1, further comprising a communication device, comprising a transmitter and a receiver, wherein the communication device is configured to access a cloud-based computing system.

4. The system of claim 3, wherein the operations of the computer system are performed by the cloud-based computing system.

5. The system of claim 1, wherein at least one document includes instructions for reconfiguring components of the system and updating components of the system.

6. The system of claim 1, wherein additional supporting software is included in the memory of the computer system.

7. A method for simulating industrial processes and industrial control systems on a testbed comprising:
integrating, by a processor, a physical environment with a virtual environment;
inputting, by the processor, at least one document comprising supporting software;
generating, by the processor, a scenario environment including the physical environment and the virtual environment linked as described in the at least one document;
generating, by the processor, a scenario within the scenario environment as described in the at least one document; and
simulating, by the processor, the scenario.

8. The method of claim 7, further comprising:
reconfiguring, by the processor, the at least one document, to include a new scenario.

9. The method of claim 7, further comprising:
returning, by the processor, results of the simulating.

10. The method of claim 7, wherein the processor is part of a cloud-based computing system.

11. The method of claim 7, further comprising:
reconfiguring, by the processor, the virtual environment and the physical environment, as described in the at least one document.

12. The method of claim 7, further comprising:
updating, by the processor, the virtual environment and the physical environment, as described in the at least one document.

13. The method of claim 7, further comprising:
recording, by the processor, onto a memory, results of the simulating.

14. A non-transitory computer readable media having computer-executable instructions embodied therein that, when executed by a computing system, causes the computing system to perform operations comprising:
integrating, by a processor, a physical environment with a virtual environment;
inputting, by the processor, at least one document comprising supporting software;
generating, by the processor, a scenario environment including the physical environment and the virtual environment linked as described in the at least one document; and
simulating, by the processor, a scenario.

15. The computer readable media of claim 14, further comprising:
reconfiguring, by the processor, the at least one document, in include a new scenario.

16. The computer readable media of claim 14, further comprising:
returning, by the processor, results of the simulating.

17. The computer readable media of claim 14, wherein the processor is part of a cloud-based computing system.

18. The computer readable media of claim 14, further comprising:
reconfiguring, by the processor, the virtual environment and the physical environment, as described in the at least one document.

19. The computer readable media of claim 14, further comprising:
updating, by the processor, the virtual environment and the physical environment, as described in the at least one document.

20. The computer readable media of claim 14, further comprising:
recording, by the processor, onto a memory, results of the simulating.
